(19) United States
(12) Patent Application Publication
(10) Pub. No.: US 2002/0195556 A1
(43) Pub. Date: Dec. 26, 2002

(54) Mass spectrometer

(75) Inventors: Kiyomi Yoshinari, Hitachi (JP); Hideshi Fukumoto, Hitachinaka (JP); Katsuhiro Nakagawa, Hitachiohta (JP); Fumihiko Nakajima, Hitachinaka (JP)

Correspondence Address: KENYON & KENYON, 1500 K Street, N.W., Suite 700, Washington, DC, 20005, US

(73) Assignee: Hitachi, Ltd.

(21) Appl. No.: 10/227,239

(22) Filed: Aug. 26, 2002

Related U.S. Application Data
(63) Continuation of application No. 09/521,598, filed on Mar. 9, 2000.

(30) Foreign Application Priority Data
Mar. 12, 1999 (JP) 10-066022

(51) Int. Cl. H01J 49/26

(52) U.S. Cl. 250/283

(57) ABSTRACT

Disclosed is a mass spectrometer capable of highly sensitively and highly efficiently measuring the masses of ions regardless of the polarity, mass numbers and energy of the ions. An ion beam transport unit (5), a conversion dynode (6) and a secondary electron detecting system (7) are disposed so that an acute angle is formed between the direction of travel of an ion beam striking on the conversion dynode (6), and a line (75) connecting the center (64) of a secondary electron exit (63) to the center (73) of a scintillator (71). The center axis (74) of the scintillator (71) lies between an end (52) of the ion transport unit (5) and the center axis (64) of the secondary electron exit (63). Since the secondary electron exit (63) is apart from an electric field created between the ion transport unit (5) and the scintillator (71), the secondary electrons are able to reach the scintillator (71) without being deflected.

### BACKGROUND OF THE INVENTION

The present invention relates to a mass spectrometer that ionizes a specimen and analyzes masses.

A deflecting system for a mass spectrometer employing a mesh electrode is disclosed in U.S. Pat. No. 5,756,993. Japanese Patent Laid-open No. Hei 10-116583 discloses a mass spectrometer that converts mass-separated ions into secondary electrons by a dynode and detects the secondary electrons emitted by the dynode.

### SUMMARY OF THE INVENTION

Miniaturization of the conversion dynode for converting an ion beam into secondary electrons is accompanied by the following problems. (1) An electric field created around a conversion dynode spreads around an entrance to the conversion dynode through which an ion beam travels and creates a penetrated electric field, secondary electrons are affected by the penetrated electric field and secondary electrons leak through the entrance. (2) The direction of an electric field applied to emitted secondary electrons in the vicinity of an exit through which secondary electrons are emitted by the conversion dynode system is greatly dependent on a position where the ion beam impinges on the conversion dynode and hence secondary electrons diverge from the exit to reduce detecting efficiency. (3) Secondary electrons emitted by the conversion dynode undergo a deflecting force before the same arrive at an electron detector, such as a scintillator, and the convergence of the beam is deteriorated to reduce detecting efficiency. (4) Since the polarity of voltage applied to a conversion dynode included in a mass spectrometer capable of analyzing both positive ions and negative ions varies according to the polarity of ions, the inclination of an electric field created in a space in front of the conversion dynode is reversed and the efficiency of arrival of ions at the conversion dynode changes according the polarity of the voltage.

It is an object of the present invention to provide a mass spectrometer capable of converting ions into electrons after mass spectrometry and capable of detecting secondary electrons at a high efficiency in a high sensitivity regardless of the polarity, mass number and energy of ions.

It is a feature of the present invention that an ion beam transporting means, a conversion dynode and a secondary electron detecting means are disposed so that an acute angle is formed between the direction of travel of an ion beam from the ion beam transporting means to the conversion dynode and a line connecting the center of a secondary electron entrance of the secondary electron detecting means to center of a secondary electron exit of the conversion dynode.

According to the present invention, since the secondary electron exit is apart from an electric field created between the ion beam transporting means and the secondary electron detecting means, the secondary electrons are able to reach the secondary electron detecting means without being deflected. Accordingly, the secondary electrons emitted by the conversion dynode reach the secondary electron detecting means efficiently, so that highly efficient, highly sensitive mass spectrometry can be achieved.

It is another feature of the present invention that only the ion beam entrance of the conversion dynode is extended upstream with respect to the direction of travel of the ion beam. Accordingly, a penetrated electric field created by the penetration of an external electric field through the ion beam entrance into the conversion dynode can be reduced and the influence of the penetrated electric field on the ion beams can be suppressed. Consequently, leakage of the secondary electrons emitted by the conversion dynode through the ion beam entrance owing to the influence of the penetrated electric field can be reduced. Thus, the secondary electrons emitted by the conversion dynode can be efficiently supplied to the secondary electron detecting means and hence highly efficient, highly sensitive mass spectrometry can be achieved.

Since the penetrated electric field penetrated inside the conversion dynode can be reduced and leakage of the secondary electrons emitted by the conversion dynode through the ion beam entrance owing to the influence of the penetrated electric field can be prevented by disposing a mesh electrode at the ion beam entrance of the conversion dynode, highly efficient, highly sensitive mass spectrometry can be achieved.

It is a further feature of the present invention that a wall-shaped electrode or a flat electrode is disposed in parallel to a plane including the ion beam entrance of the conversion dynode around the ion beam exit of the ion beam transporting means. Since the direction of an electric field created between the ion beam transporting means and the conversion dynode is substantially perpendicular to the ion beam entrance regardless of the polarity of the voltage applied to the conversion dynode, the convergence of the ion beam is improved and the ion beam strikes efficiently on the conversion dynode regardless of the polarity of ions. Accordingly, efficient mass spectrometry can be achieved.

Since unnecessary neutral molecules can be removed from the ion beam by making the ion beam strike on the ion beam transporting means after being deflected by the ion beam deflecting means, the generation of noise by neutral molecules can be suppressed and S/N ratio can be improved. Consequently, accurate mass spectrometric analysis can be achieved.

Highly sensitive detection can be achieved regardless of the polarity, energy and mass number of ions by optimizing the shape of the conversion dynode, and the relative positional relation between the conversion dynode and the secondary electron detecting means.

The above and other features of the present invention will become more apparent from the following description.

### BRIEF DESCRIPTION OF THE DRAWINGS

FIG. 1 is a schematic view of components of a mass spectrometer in a first embodiment according to the present invention including a mass spectrometric system 3 to a scintillator 71;

FIG. 2 is a block diagram of the mass spectrometer in the first embodiment;

FIGS. 3A and 3B are diagrammatic views showing the results of numerical analysis of ion trajectories between the mass spectrometric system 3 and the scintillator 71 in the first embodiment;

FIG. 4 is a schematic view of a conversion dynode 6b;

FIG. 5 is a schematic view of a conversion dynode 6c;

FIG. 6 is a schematic view of components of a mass spectrometer in a second embodiment according to the present invention including a mass spectrometric system 3 to a scintillator 71;

FIG. 7 is a diagrammatic view showing the results of numerical analysis of ion trajectories between the mass spectrometric system 3 and the scintillator 71 in the second embodiment;

FIG. 8 is a schematic view of components of a mass spectrometer in a third embodiment according to the present invention including a mass spectrometric system 3 to a scintillator 71;

FIG. 9 is a diagrammatic view showing the results of numerical analysis of ion trajectories between the mass spectrometric system 3 and the scintillator 71 in the third embodiment;

FIG. 10 is a schematic view of components of a mass spectrometer in a fourth embodiment according to the present invention including a mass spectrometric system 3 to a scintillator 71;

FIG. 11 is a diagrammatic view showing the results of numerical analysis of ion trajectories between the mass spectrometric system 3 and the scintillator 71 in the fourth embodiment;

FIG. 12 is a schematic view of components of a mass spectrometer in a fifth embodiment according to the present invention including a mass spectrometric system 3 to a scintillator 71;

FIGS. 13A and 13B are diagrammatic views showing the result of numerical analysis of ion trajectories between the mass spectrometric system 3 and the scintillator 71 in the fifth embodiment; and

FIG. 14 is a schematic view of another mass spectrometer.

### DETAILED DESCRIPTION

Preferred embodiments of the present invention will be described with reference to the accompanying drawings, in which the same reference characters denote the same or corresponding parts.

First Embodiment

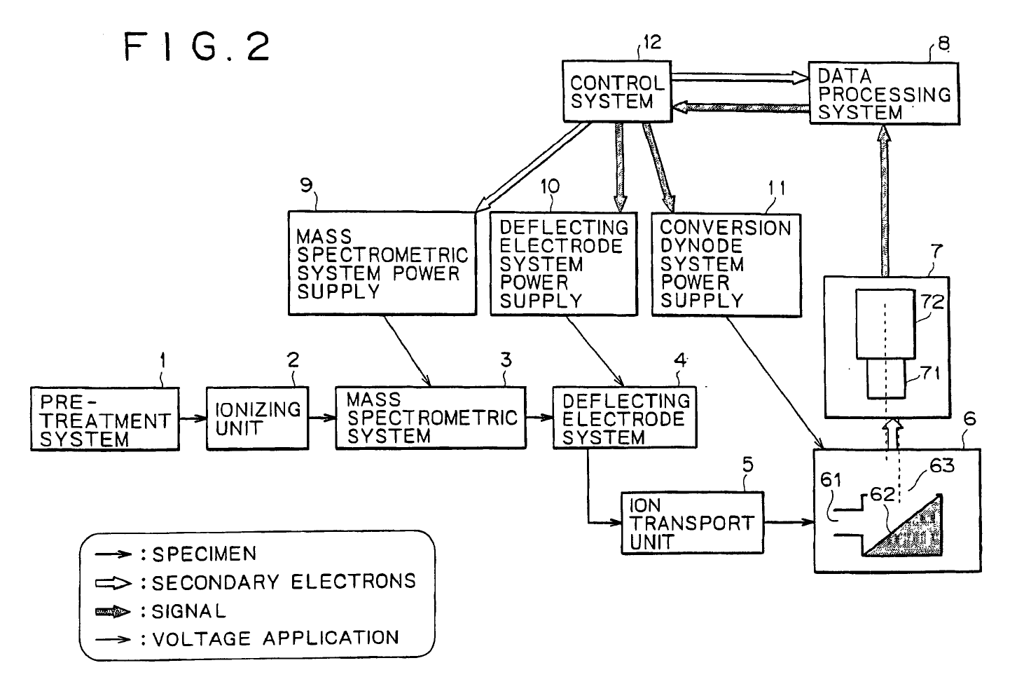

A mass spectrometer in a first embodiment according to the present invention will be described. FIG. 2 is a block diagram of the mass spectrometer in the first embodiment. The components of a specimen are separated by a pretreatment system 1 using a gas chromatograph (GC) or a liquid chromatograph (LC). A ionizing unit 2 ionizes the components of the specimen and a mass spectrometric system 3 carries out mass spectrometry. An ion beam undergone mass spectrometry is deflected by a deflection electrode system 4, travels through an ion transport unit 5 and strikes on a conversion dynode 6 through an ion beam entrance 61 formed in the conversion dynode 6. The conversion dynode 6 emits secondary electrons upon the impingement of the ion beam on an impingement surface 62 of the conversion dynode 6. The secondary electrons are emitted through a secondary electron exit 63, strike on an electron detecting unit 7 provided with a scintillator 71 or the like. The scintillator 71 detects the secondary electrons. Light emitted by the scintillator 71 is converted into a corresponding electric signal by a photomultiplier 72, and a data processing unit 8 processes the electric signal. The secondary electrons may be detected by an electron detecting unit other than the electron detecting unit 7, such as a multiplier. Power supplies 9 to 11 apply voltages to the mass spectrometric system 3, the deflection electrode system 4 and the conversion dynode 6, respectively.

A control system 12 controls operations for producing specimen ions by a series of mass spectrometric processes, mass spectrometric analysis of specimen ions, voltage application to the mass spectrometric system 3, the deflection electrode system 4 and the conversion dynode 6, secondary electron detection, and data processing.

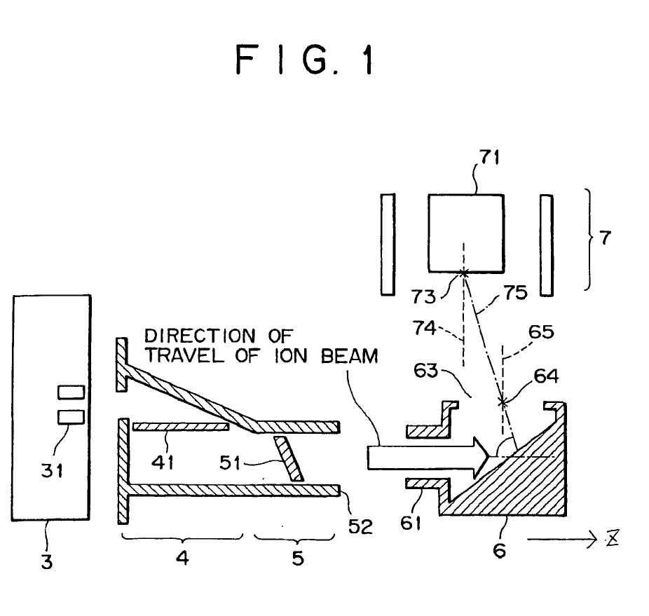

As shown in FIG. 1, the ion beam emitted by the ion trap type mass spectrometric system 3 is deflected by a mesh electrode 41 included in the deflection electrode system 4. The ions analyzed by the ion trap type mass spectrometric system 3 have an energy width of, for example, about 500 eV when the masses of the analyzed ions are in the range of 10 to 2000 amu, and the energy width is substantially proportional the mass number of the ions. The mesh electrode 41 is suitable for satisfactorily converging a beam having an energy dispersion. The ion beam deflected by the deflecting electrode system 4 is transported to the conversion dynode 6 by the ion transport unit 5 provided with a mesh electrode 51 similarly to the deflecting electrode system 4. The conversion dynode 6 has the ion beam entrance 61 having the shape of a projection. The ion beam entrance 61 reduces a penetrated electric field created by an external electric field penetrated through the ion beam entrance 61 into the conversion dynode 6 to suppress the influence of the penetrated electric field on the ion beam. Thus, it is possible to reduce the leakage of the secondary electrons produced in the conversion dynode 6 through the ion beam entrance 61 owing to the effect of the penetrated electric field.

The secondary electron exit 63 of the conversion dynode 6 opens toward the scintillator 71. The ion beam transport unit 5, the conversion dynode 6 and the secondary electron detecting system 7 are disposed so that the direction of travel of the ion beam from the ion beam transport unit 5 to the conversion dynode 6 and a line 75 connecting the center 64 of the secondary electron exit 63 to the center 73 of the scintillator 71 form an acute angle. Thus, the center axis 74 of the scintillator 7 and the center axis 64 of the secondary electron exit 63 are not aligned, and the center axis 74 of the scintillator 71 lies in a space between an end 52 of the ion transport unit 5 and the center axis 64 of the secondary electron exit 63.

In the mass spectrometer in this embodiment, there is an angular difference of 90° between the direction of an electric field created between the ion transport unit 5 and the ion beam entrance 61, and that of an electric field created between the secondary electron exit 63 and the scintillator 71, and the direction of an electric field created between the ion transport unit 5 and the scintillator 71 is different from that of an electric field created between the secondary electron exit 63 and the scintillator 71. In the prior art mass spectrometer, secondary electrons discharged through a region of the secondary electron exit 63 on the side of the ion transport unit 5 are affected and deflected by the electric field created between the ion transport unit 5 and the scintillator 71 and fail in reaching the scintillator 71. In this embodiment, the secondary electrons are not deflected and are able to reach the scintillator 71 because the secondary electron exit 63 is apart from the electric field created between the ion transport unit 5 and the scintillator 71. Consequently, secondary electron detecting efficiency is improved.

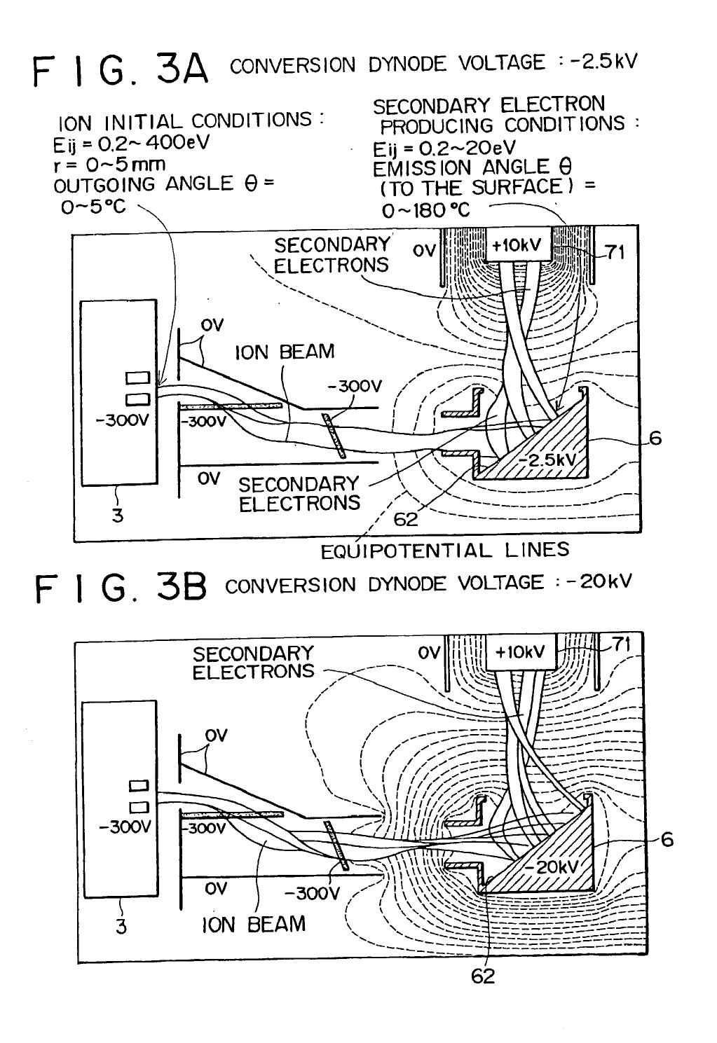

FIGS. 3A and 3B are diagrammatic views showing the results of numerical analysis of ion trajectories between the mass spectrometric system 3 and the scintillator 71 of the mass spectrometer in this embodiment when the voltage applied to the conversion dynode 6 was −2.5 kV and −20 kV. The numerical analysis was conducted on an assumption that the ions are positive ions. A voltage equal to a voltage (−300 V) applied to a drawing electrode 31 is applied to both the mesh electrode 41 of the deflecting electrode system 4 and the mesh electrode 51 of the ion transport unit 5.

As shown in FIGS. 3A and 3B, the ion beam emitted by the mass spectrometric system 3 strikes on the conversion dynode 6, a beam of secondary electrons emitted from the impingement surface 62 is converged in high convergence and the secondary electrons reach the scintillator 71 efficiently in both a case where −2.5 kV is applied to the conversion dynode 6 and a case where −20 KV is applied to the same.

In the mass spectrometer in this embodiment, the ion beam is able to strike efficiently on the conversion dynode 6 even if a high voltage is applied to the conversion dynode 6, and the secondary electrons produced by the conversion dynode 6 are able to reach the scintillator 71 efficiently. Therefore, highly efficient, highly sensitive mass spectrometry of ions can be achieved even if the ions have large mass numbers.

Since the ion beam emitted by the mass spectrometric system 3 is detected after deflection by the deflecting electrode system 4, unnecessary neutral molecules produced by the pretreatment system 1 provided with a gas chromatograph or a liquid chromatograph can be removed, generation of noise attributable to neutral molecules can be suppressed and the S/N ratio can be improved.

Since the ion beam emitted by the mass spectrometric system 3 strikes on the conversion dynode 6 after deflection by the deflecting electrode system 4, a beam emission axis along which the mass spectrometric system 3 emits the ion beam is not aligned with the center axis of the ion beam entrance 61. Therefore, when ionizing the specimen by the electron gun of the ionizing unit 2, light emitted by the filament of the electron gun does not strike directly on the conversion dynode 6 and the light is not reflected by the impingement surface 62 and does not strike on the scintillator 71. Thus, noise due to the entrance of external light into the scintillator 71 can be reduced.

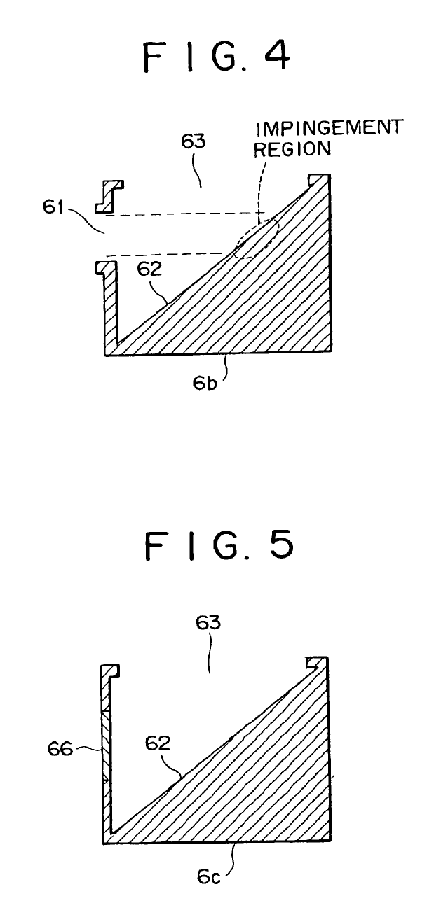

A conversion dynode 6b as shown in FIG. 4 may be employed instead of the conversion dynode 6. The conversion dynode 6b is provided with an ion beam entrance 61 so as to correspond to a region of an impingement surface 62 on the upper side of a central region of the impingement surface 62 so that an ion beam impinges on an upper region of the impingement surface 62. Since secondary electrons are produced in the depth of the conversion dynode 6b, the secondary electrons are affected scarcely by the penetrated electric field created in the vicinity of the ion beam entrance 61 and the leakage of the secondary electrons through the ion beam entrance 61 can be reduced. Therefore, the ion beam entrance 61 of the conversion dynode 6b having the shape of a projection may be short or the projection of the ion beam entrance 61 may be omitted. Since the closer a penetrated electric field created in the vicinity of the secondary electron exit 63 of the conversion dynode 6b to the secondary electron exit 63, the higher the secondary electron pulling force, and the secondary electrons are pulled in a direction substantially perpendicular to the secondary electron exit 63, the secondary electrons produced by the conversion dynode 6b can highly efficiently reach the scintillator 71.

A conversion dynode 6c as shown in FIG. 5 may be employed instead of the conversion dynode 6. The conversion dynode 6c is provided with a mesh electrode 66 of the same potential as the conversion dynode 6 fitted in an ion beam entrance 61. Although an ion beam travels through the mesh electrode 66 at the ion beam entrance 61, the leakage of secondary electrons through the ion beam entrance 61 can be reduced because any penetrated electric field is not created in a region of the interior of the conversion dynode 6c in the vicinity of the ion bean entrance 61.

Second Embodiment

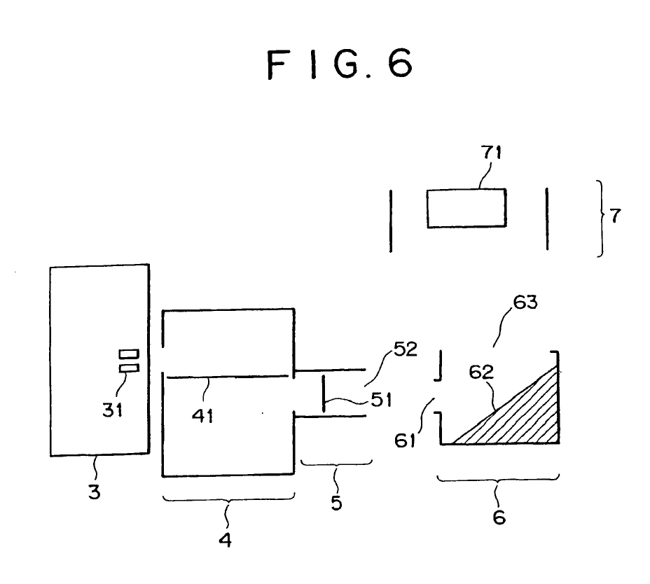

A mass spectrometer in a second embodiment according to the present invention will be described hereinafter. FIG. 6 a schematic view showing components of the mass spectrometer in the second embodiment including a mass spectrometric system 3 to a scintillator 71. A conversion dynode 6 employed in this embodiment is formed so that an ion beam impinges on a deep part of an impingement surface 62, and the inclination of an electric field created between the conversion dynode 6 and an ion transport unit 5 is substantially perpendicular to an ion beam entrance 61 regardless of the polarity of voltage applied to the conversion dynode 6.

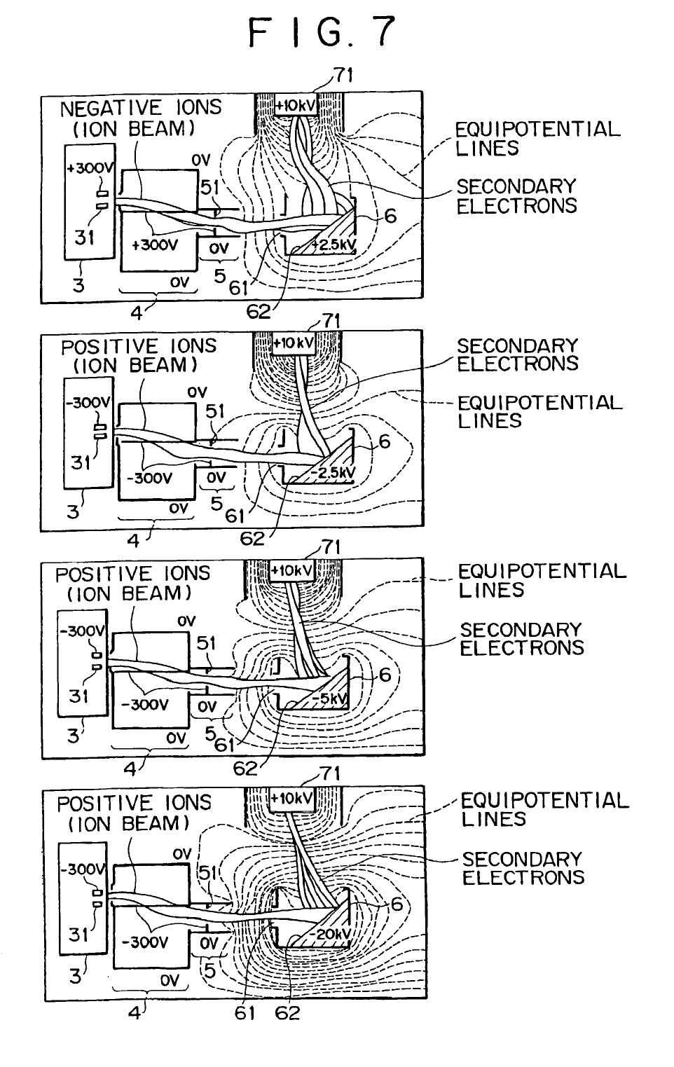

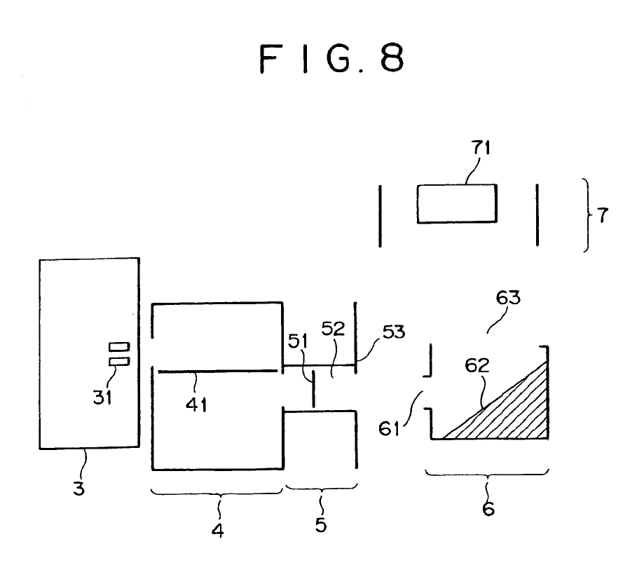

FIG. 7 shows the results of numerical analysis of ion trajectories between the mass spectrometric system 3 and the scintillator 71 of the mass spectrometer in this embodiment for four conditions. The respective polarities of voltages applied to a drawing electrode 31, a deflecting electrode system 4, the mesh electrode 51 of the ion transport unit 5 and the conversion dynode 6 for positive ions are inverse to those of voltages applied to the same for negative ions, respectively. The results of analysis show that both the positive and negative ion beams are converged satisfactorily, strike efficiently on the conversion dynode 6, and secondary electrons produced by the conversion dynode 6 strike highly efficiently on the scintillator 71.

It was found that the ion beams fell efficiently on the conversion dynode 6 for voltages in a wide range of −2.5 to −20 KV applied to the conversion dynode 6, and the secondary electrons were able to strike highly efficiently on the scintillator 71.

In the conventional mass spectrometer, the inclination of an electric field created in front of the entrance 61 of a conversion dynode changes according to the polarity of voltage applied to the conversion dynode, and the position of a region in an impingement surface 62 of the conversion dynode on which an ion beam impinges changes greatly when the polarity of the ion beam changes, resulting in that ion beam incidence efficiency and secondary electron yield change greatly according to the polarity of the ion beam. In this embodiment, the electric field created between the ion transport unit 5 and the conversion dynode 6 is substantially perpendicular to the ion beam entrance 61 of the conversion dynode 6 as shown in FIG. 7 regardless of the polarity and energy (ion mass) of the ions. Therefore, positive ions and negative ions impinge on the impingement surface 62 in substantially the same region, and the efficiency at which the ion beam strikes on the conversion dynode 6, and the efficiency at which the secondary electrons reach the scintillator 71 are improved. Accordingly, this embodiment is capable of achieving mass spectrometry at a high efficiency regardless of the polarity of the ions for analysis.

Third Embodiment

A mass spectrometer in a third embodiment according to the present invention will be described. FIG. 8 is a schematic view showing components of the mass spectrometer in the third embodiment including a mass spectrometric system 3 to a scintillator 71. The third embodiment employs an ion transport unit 5 similar to that employed in the second embodiment and provided with a wall-shaped electrode 53 around the ion beam exit 52 thereof.

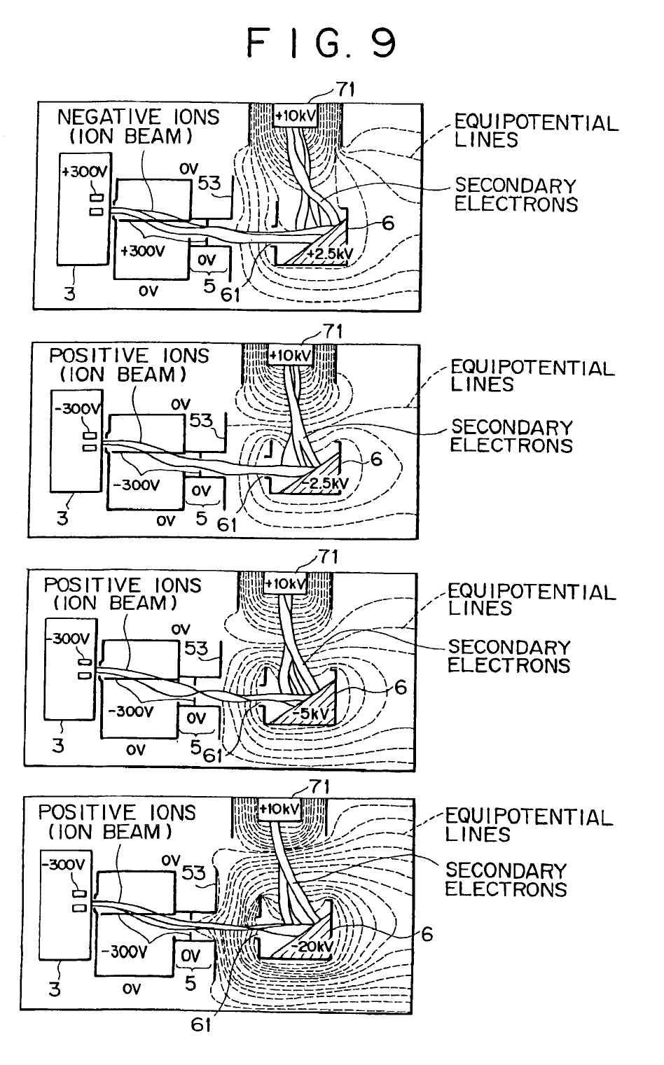

FIG. 9 shows the results of numerical analysis of ion trajectories between the mass spectrometric system 3 and the scintillator 71 of the mass spectrometer in this embodiment for four conditions. Since the mass spectrometer in this embodiment is provided with the wall-shaped electrode 53, the direction of an electric field created between the ion transport unit 5 and the conversion dynode 6 is more perpendicular to the ion beam entrance 61 of the conversion dynode 6, the convergence of both positive and negative ion beams is further improved, and the positive and the negative ion beams are able to strike more efficiently on the conversion dynode 6. Since a position where the negative ion beam impinges on an impingement surface 62 and a position where the positive ion beam impinges on the impingement surface 62 are close to each other, the convergence of the negative ion beam is higher than that of the negative ions in the second embodiment.

Thus, this embodiment improves the convergence of primary beams regardless of the polarity of ions and is capable of achieving highly efficient mass spectrometry.

Fourth Embodiment

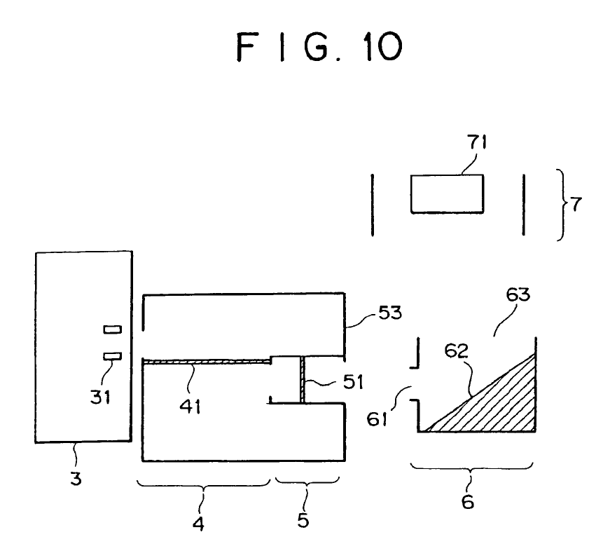

A mass spectrometer in a fourth embodiment according to the present invention will be described hereinafter. FIG. 10 is a schematic view showing components of the mass spectrometer in the third embodiment including a mass spectrometric system 3 to a scintillator 71. In this embodiment, the ion transport unit 5 is included in the deflecting electrode system 4.

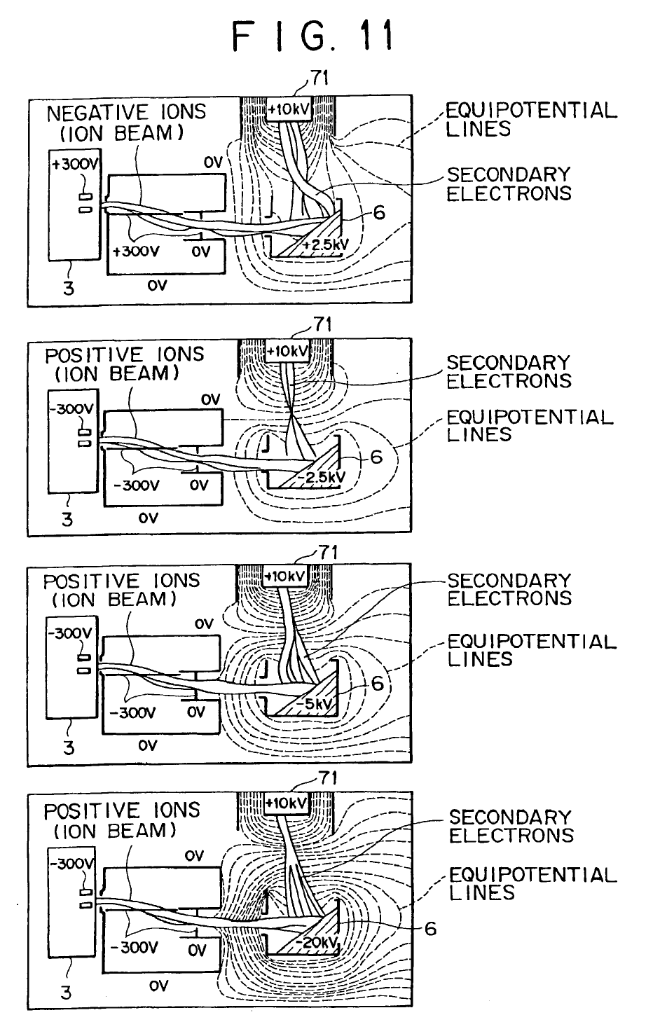

FIG. 11 shows the results of numerical analysis of ion trajectories between the mass spectrometric system 3 and the scintillator 71 of the mass spectrometer in this embodiment for four conditions. This embodiment, similarly to the third embodiment, further improves the convergence of primary beams of both positive and negative ions and makes the ion beam strike on the conversion dynode 6 more efficiently. Thus, this embodiment further improves the convergence of the primary beam regardless of the polarity of ions and is capable of achieving further efficient mass spectrometry. Since the deflecting electrode system 4 and the ion transport unit 5 are simple in construction, the deflecting electrode system 4 can be very easily fabricated.

Fifth Embodiment

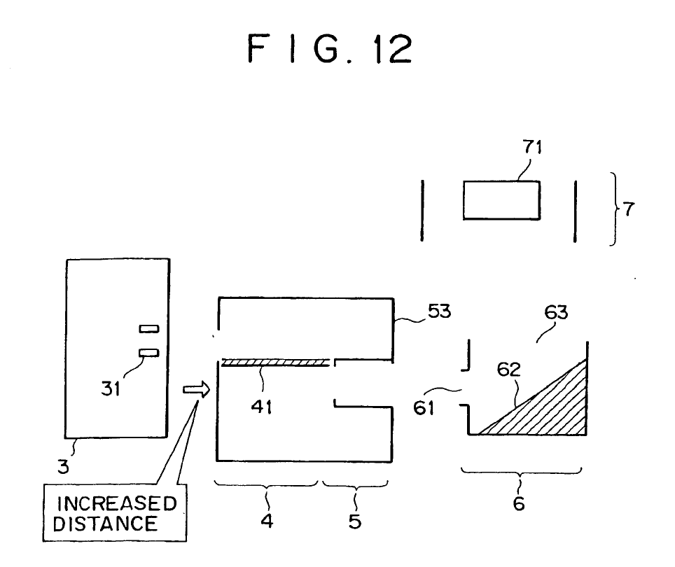

A mass spectrometer in a fifth embodiment according to the present invention will be described hereinafter. FIG. 12 is a schematic view showing components of the mass spectrometer in the fifth embodiment including a mass spectrometric system 3 to a scintillator 71. The distance between the drawing electrode 31 and the deflecting electrode system 4 in this embodiment is longer than that in the third embodiment shown in FIG. 10, and the length of the ion transport unit 5 is shorter than that of the third embodiment. The ion transport unit 5 is not provided with any mesh electrode.

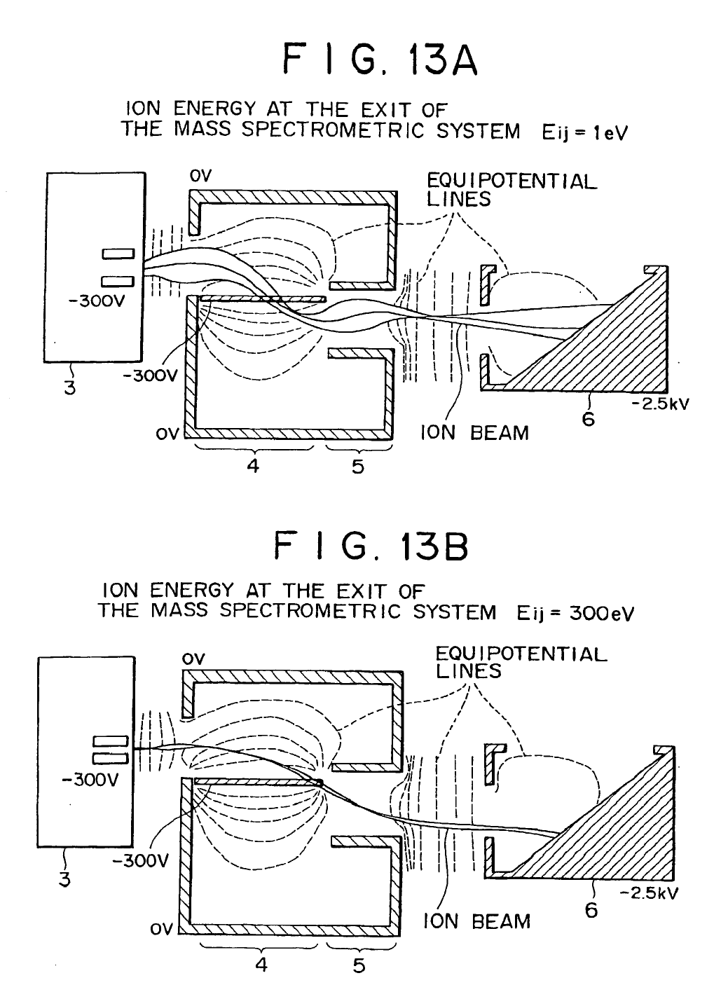

FIGS. 13A and 13B shows the results of numerical analysis of ion trajectories between the mass spectrometric system 3 and the scintillator 71 of the mass spectrometer in this embodiment for two conditions. FIGS. 13A and 13B show the results of three-dimensional analysis. In FIGS. 13A and 13B, a analytic system is divided into a plurality of regions and then calculation is made and hence the results are shown separately. Since the distance between the drawing electrode 31 and the deflecting electrode system 4 is extended, the ion beam diverges slightly at the entrance of the deflecting electrode system 4 and is deflected at a position near the conversion dynode 6. However, since the ion transport unit 5 is short, the ion beam is stable and can be satisfactorily converged before striking on the conversion dynode 6 even if the ion transport unit 5 is not provided with any mesh electrode.

Since this embodiment does not need any mesh electrode, the ratio of ions lost as the ion beam passes a mesh electrode can be reduced, and the mass spectrometer is simple in construction and ca be fabricated easily at a reduced cost.

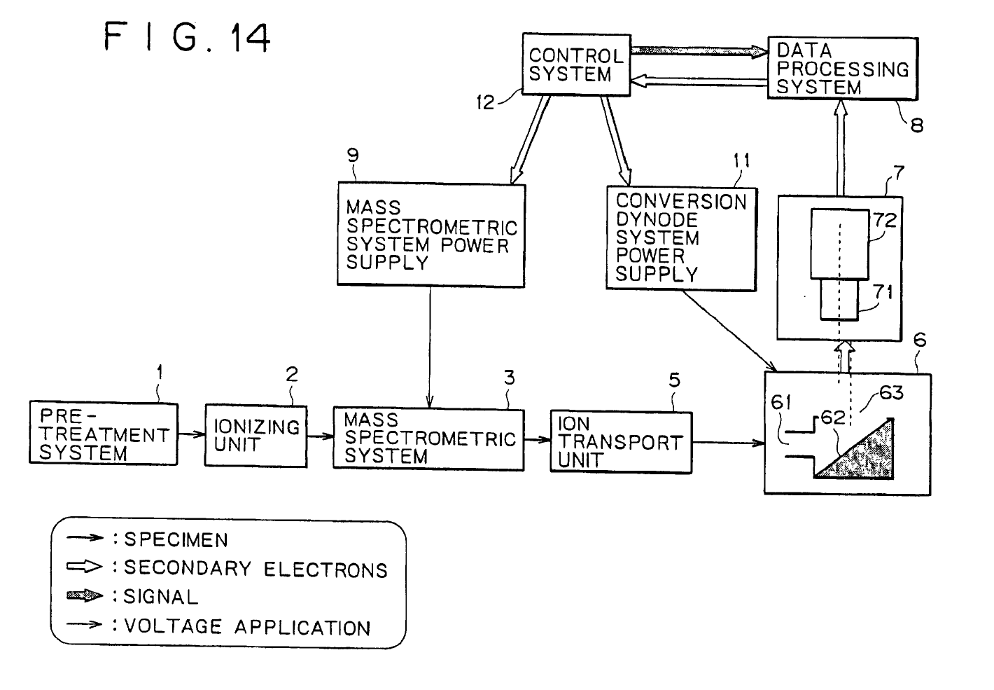

In the foregoing embodiments, the ion beam drawn out from the mass spectrometric system 3 strikes on the conversion dynode 6 after being deflected by the deflecting electrode system 4. A mass spectrometer not provided with any deflecting electrode system as shown in FIG. 14 may be used. The mass spectrometer shown in FIG. 14 may transport an ion beam drawn out from a mass spectrometric system 3 directly to a conversion dynode 6 without deflecting the ion beam by a deflecting electrode system. Since the primary ion beam is not deflected, the convergence of the primary ion beam is improved, the primary ion beam strikes in a small impingement region. Consequently, the convergence of secondary electrons is improved and the efficiency of secondary electron detection is improved. If ion beam deflection to avoid noise generation by unnecessary neutral molecules and light is not necessary, it is desirable to omit the deflecting electrode system 4.

Since the ion beam transporting means, the conversion dynode and the secondary electron detecting means are arranged so that an acute angle is formed between the direction of travel of the ion beam transported by the ion beam transporting means to the conversion dynode and a line connecting the center of the secondary electron entrance of the secondary electron detecting means to the center of the secondary electron exit of the conversion dynode, the secondary electron exit is apart from the electric field created between the ion beam transporting means and the secondary electron detecting means. Consequently, the secondary electrons are able to reach the secondary electron detecting means without being deflected. Since the secondary electrons produced by the conversion dynode are able to reach the secondary electron detecting means efficiently, highly efficient, highly sensitive mass spectrometry can be achieved.

Since the ion beam entrance of the conversion dynode is extended upstream with respect to the direction of travel of the ion beam, a penetrated electric field created by the penetration of an external electric field through the ion beam entrance into the conversion dynode can be reduced and the influence of the penetrated electric field on the ion beams can be suppressed. Consequently, leakage of the secondary electrons emitted by the conversion dynode through the ion beam entrance owing to the influence of the penetrated electric field can be reduced. Thus, the secondary electrons emitted by the conversion dynode can be efficiently supplied to the secondary electron detecting means and hence highly efficient, highly sensitive mass spectrometry can be achieved.

Since the penetrated electric field penetrated inside the conversion dynode can be reduced and leakage of the secondary electrons emitted by the conversion dynode through the ion beam entrance owing to the influence of the penetrated electric field can be reduced by disposing the mesh electrode at the ion beam entrance of the conversion dynode, highly efficient, highly sensitive mass spectrometry can be achieved.

Since the wall-shaped electrode is disposed in parallel to a plane including the ion beam entrance of the conversion dynode around the ion beam exit of the ion beam transporting means, the direction of the electric field created between the ion beam transporting means and the conversion dynode is substantially perpendicular to the ion beam entrance regardless of the polarity of the voltage applied to the conversion dynode. Therefore, the convergence of the ion beam is improved and the ion beam strikes efficiently on the conversion dynode regardless of the polarity of ions. Accordingly, efficient mass spectrometry can be achieved.

Since the ion beam strikes on the ion beam transporting means after being deflected by the ion beam deflecting means, unnecessary neutral molecules contained in the ion beam can be removed. Thus, noise generation by neutral molecules can be suppressed and the S/N ratio is improved. Consequently, accurate mass spectrometry can be achieved.

What is claimed is:

1. A mass spectrometer comprising:
a mass spectrometric means for analyzing masses of ions;
an ion beam transporting means for transporting an ion beam analyzed by the mass spectrometric means;
a conversion dynode that emits secondary electrons upon the impingement of the ion beam transported by said ion beam transporting means thereon; and
a secondary electron detecting means for detecting the secondary electrons emitted by the conversion dynode upon the impingement of the ion beam thereon;
wherein an acute angle is formed between a direction in which the ion beam transporting means transports the ion beam to the conversion dynode, and a line connecting a center of a secondary electron entrance through which the secondary electrons strike on the secondary electron detecting means to a center of a secondary electron exit through which the secondary electrons emitted by the conversion dynode travel toward the secondary electron detecting means.

2. The mass spectrometer according to claim 1, wherein the secondary electron detecting means is a scintillator, and the scintillator is disposed so that its center axis lies between a center axis of the conversion dynode and the ion beam transporting means.

3. A mass spectrometer comprising:
a mass spectrometric means for analyzing masses of ions;
an ion beam transporting means for transporting an ion beam analyzed by the mass spectrometric means;
a conversion dynode that emits secondary electrons upon the impingement of the ion beam transported by said ion beam transporting means thereon; and
a secondary electron detecting means for detecting the secondary electrons emitted by the conversion dynode upon the impingement of the ion beam thereon;
wherein an ion beam entrance through which the ion beam transported by the ion beam transporting means enters the conversion dynode is extended upstream with respect to the direction of travel of the ion beam.

4. The mass spectrometer according to claim 1, further comprising an ion beam deflecting means for deflecting the ion beam to make the ion beam enter the ion beam transporting means after deflecting the same by the ion beam deflecting means

5. The mass spectrometer according to claim 1, wherein the mass spectrometric means is an ion trap mass spectrometer.

6. The mass spectrometer according to claim 3, further comprising an ion beam deflecting means for deflecting the ion beam to make the ion beam enter the ion beam transporting means after deflecting the same by the ion beam deflecting means.

7. The mass spectrometer according to claim 3, wherein the mass spectrometric means is an ion trap mass spectrometer.
